(19) United States
(12) Patent Application Publication
(10) Pub. No.: US 2005/0224367 A1
(43) Pub. Date: Oct. 13, 2005

(54) Device and method for removing surface areas of a component

(76) Inventors: Daniel Kortvelyessy, Berlin (DE); Ralph Reiche, Berlin (DE); Jan Steinbach, Berlin (DE); Marc de Vogelaere, Berlin (DE)

Correspondence Address: Siemens Corporation;Intellectual Property Department, 170 Wood Avenue South, Iselin, NJ, 08830, US

(21) Appl. No.: 10/511,251

(22) PCT Filed: Mar. 12, 2003
(86) PCT No.: PCT/DE03/00953

§ 371 Date: May 10, 2005

(30) Foreign Application Priority Data
Apr. 8, 2002 (DE) 102 15 374.4
Dec. 8, 2002 (DE) 102 59 365.5

(51) Int. Cl. B23H 9/10

(52) U.S. Cl. 205/646

(57) ABSTRACT

The prior art involves removing surface regions of a metallic component by means of electrochemical processes.

The electrochemical process is accelerated by the use of a current pulse generator (16).

The invention relates to an apparatus and a process for removing surface regions of a component as described in claim 1 or 3, respectively.

Hitherto, components which have been coated with coatings of type MCrAlY or ZrO₂ have had the coating removed, for example, by acid stripping in combination with sand blasting or by high-pressure water blasting.

EP 1 122 323 A1 and U.S. Pat. No. 5,944,909 show examples of the chemical removal of surface regions.

EP 1 941 34 A1, EP 1 010 782 A1 and U.S. Pat. No. 6,165,345 disclose methods for the electrochemical removal of metallic coatings (stripping).

The processes listed above are time-consuming and therefore expensive.

It is an object of the invention to provide an apparatus and a process in which the removal of the coating takes place more quickly and economically.

The object is achieved by an apparatus and a process for the removal of surface regions from a component as described in claims 1 and 3, respectively.

Further advantageous configurations and process steps are listed in the corresponding subclaims.

In the drawing:

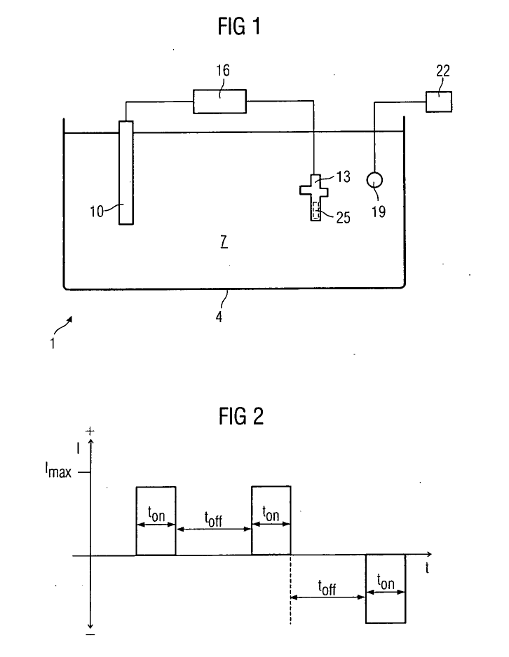

FIG. 1 shows an apparatus according to the invention,

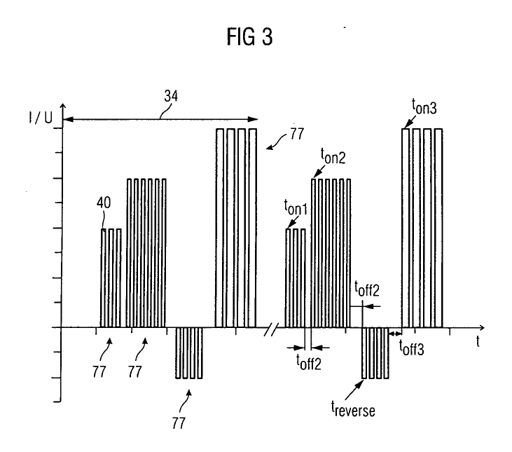

FIG. 2 shows a time curve of a current of a current pulse generator, and

FIG. 3 shows a further time curve of a current from a current pulse generator.

FIG. 1 shows an apparatus 1 according to the invention. The apparatus 1 comprises a vessel 4 in which an electrolyte 7 there is arranged. An electrode 10 and a component 13 are arranged in the electrolyte 7. The electrode 10 and the component 13 are electrically connected to a current/voltage pulse generator 16. The component 13 is, for example, a coated turbine blade or vane, the substrate of which is a nickel- or cobalt-base superalloy, to which a metallic layer has been applied to serve, for example, as a corrosion-resistant or anchoring layer. A layer of this type in particular has the composition MCrAlY, where M stands for an element iron, cobalt or nickel.

The coating has been corroded during use of the turbine blade or vane 13. The surface region 25 which has been formed as a result (as indicated by dashed lines) is to be removed by the process according to the invention and the apparatus 1 according to the invention. It is also possible for layer regions 25 which have been formed by corrosion, oxidation or other forms of degradation to be removed from a component 13 which does not have a coating, these layer regions being in the vicinity of the surface. The current pulse generator 16 generates a pulsed current/voltage signal (FIG. 2).

An ultrasound probe 19, which is operated by an ultrasound source 22, may optionally be arranged in the electrolyte 7.

The ultrasound excitation improves the hydrodynamics of the process and thereby assists the electrochemical reaction.

FIG. 2 shows an example of a current/voltage curve of the current/voltage pulse generator 16.

The current pulse signal or the voltage pulse is, for example, square-wave (pulse shape) and has a pulse duration tₒₙ. Between the individual pulses there is an interval of length t_{off}. Furthermore, the current pulse signal is defined by its current level Iₘₐₓ.

The current (Iₘₐₓ) which flows between the electrode 10 and the component 13, the pulse duration (tₒₙ) and the pulse interval (t_{off}) have a significant influence on the electrochemical reaction by accelerating the latter.

FIG. 3 shows an example of a series of current pulses 40 which are repeated. A sequence 34 comprises at least two blocks 77. Each block 77 comprises at least one current pulse 40. A current pulse 40 is characterized by its duration tₒₙ, the level Iₘₐₓ and its pulse shape (square-wave, delta, etc.). Other important process parameters are the intervals between the individual current pulses 40 (t_{off}) and the intervals between the blocks 77.

The sequence 34 comprises, for example, a first block 77 of three current pulses 40 between each of which there is an interval. This is followed by a second block 77, which has a higher current level and comprises six current pulses 40. After a further interval, there then follow four current pulses 40 in the opposite direction, i.e. with a reversed polarity.

The sequence 34 is finished by a further block 77 of four current pulses.

The sequence 34 can be repeated a number of times.

The individual pulse times tₒₙ are preferably of the order of magnitude of approximately 1 to 10 milliseconds. The time duration of the block 77 is of the order of magnitude of up to 10 seconds, so that up to 500 pulses are emitted in one block 77.

The application of a low potential (base current) both during the pulse sequences and during the intervals is optionally possible.

The parameters of a block 77 are matched to a constituent of an alloy which, by way of example, is to be removed in order to optimize the removal of this constituent. This can be determined in individual tests.

1. An apparatus for removing surface regions from a component,
which has a vessel in which an electrolyte is arranged,
into which the component can be introduced,
which has an electrode,
it being possible for the electrode and the component to be electrically connected to one another, and
the electrode being arranged at least partially in the electrolyte,
characterized in that
the apparatus has an electrical current pulse generator (16), which can be electrically connected between electrode (10) and component (13),
in that the current pulse generator (16) can generate current pulses.

2. The apparatus as claimed in claim 1,
characterized in that
the apparatus (1) has an ultrasound probe (14),
which is arranged in the container (4), and
which is surrounded by the electrolyte (10).

3. A process for removing a coating from a surface region of a component,
in which an electrode and the component are arranged in an electrolyte, the electrode and the component being electrically conductively connected to one another and to a current generator (16),
characterized in that
the current generator (16) generates a pulsed current or a pulsed voltage.

4. The process as claimed in claim 3,
characterized in that
a positive or a negative potential is applied to the component (13) in order to generate a base current or base voltage.

5. The process as claimed in claim 3,
characterized in that
an ultrasound probe (19) is operated in the electrolyte (7).

6. The process as claimed in claim 3,
characterized in that
a current/voltage pulse (40) is used for the electrolytic coating removal, with both positive and negative current/voltage pulses (40) being used.

7. The process as claimed in claim 1,
characterized in that
for the electrolytic coating removal a plurality of current/voltage pulses (40) are used repeatedly combined in a sequence (34),
the sequence (34) being formed by at least two different blocks (77),
one block (77) comprising at least one current pulse (40).

8. The process as claimed in claim 7,
characterized in that
a block (77) is defined by a number of current pulses (40), pulse duration (tₒₙ), pulse interval (t_{off}), current level (Iₘₐₓ) and pulse shape.

9. The process as claimed in claim 7,
characterized in that
a block (77) is in each case matched to a constituent of an alloy which is to be removed in order to boost the removal of the constituent of the alloy.

10. The process as claimed in claim 1,
characterized in that
the coating removed is an alloy layer of MCrAlY type, where M is an element selected from the group consisting of iron, cobalt or nickel.

11. The process as claimed in claim 7,
characterized in that
a base current is superimposed on the current pulses (40) and/or the intervals.
